(19) United States
(12) Patent Application Publication
(10) Pub. No.: US 2008/0114789 A1
(43) Pub. Date: May 15, 2008

(54) DATA ITEM RETRIEVAL METHOD AND APPARATUS

(76) Inventor: John A. Wysham, Vienna, VA (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(21) Appl. No.: 11/871,442

(22) Filed: Oct. 12, 2007

Related U.S. Application Data
(60) Provisional application No. 60/858,943, filed on Nov. 15, 2006.

(51) Int. Cl. G06F 17/30

(52) U.S. Cl. 707/100; 707/E17.005

(57) ABSTRACT

Methods and Apparatuses for characterizing locators of data items and facilitating retrieval of the data items through the characterization are disclosed and described herein.

### RELATED APPLICATIONS

The present application claims priority to U.S. Provisional Application 60/858,943 entitled “Databrand Software”, filed on Nov. 15, 2006. The specification of the 60/858,943 provisional application is hereby fully incorporated by reference.

### FIELD

The present invention relates generally to the field of data processing and more specifically, to methods and apparatuses for retrieval, storage, characterization and organization of electronic data—for example, data items—in a manner which is more efficient and which may be more intuitive for the computer system user.

### BACKGROUND

Advances in storage technology have resulted in devices with higher capacity storage in ever smaller forms. This, combined with faster communication between system components and networks, allows ever greater opportunities to store and access electronic data. Consumer demand to store electronic data seemingly shows no sign of diminishing. Conventionally, electronic data may be organized into a hierarchy of folders; however, experience has shown that it is increasingly difficult to quickly locate and retrieve electronic data under such an approach. To resolve such issues, search technology is often employed. However, even this technology is sometimes insufficiently efficient or intuitive for the growing number of novice computing device users. There is growing demand for a more efficient, intuitive technology to access, organize, manipulate and retrieve data. The value of stored data is greatly enhanced when data items can be easily located and manipulated.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates an overview of the invention, in accordance with various embodiments;

FIG. 2 illustrates some aspects of data organization, in accordance with various embodiments;

FIG. 3 is a flow chart depicting various embodiments of the invention for identifying storage location, classification, retrieving and searching, in accordance with various embodiments;

FIG. 4 illustrates a screen shot of an item table, in accordance with various embodiments;

FIG. 5 illustrates a screen shot of a classification table, in accordance with various embodiments;

FIG. 6 illustrates a screen shot of a resulting recordset, in accordance with various embodiments;

FIG. 7 illustrates a screen shot of a drop down combo box showing various criteria available, in accordance with various embodiments;

FIG. 8 illustrates a screen shot of the Getfile form when it is empty—before the Getfile program is activated—in accordance with various embodiments;

FIG. 9 illustrates a screen shot of the “Getfile” form, in accordance with various embodiments;

FIG. 10 illustrates a screen shot of the result of multiple data items being opened in one action, in accordance with various embodiments; and

FIG. 11 illustrates an exemplary computing device capable of performing the operations of various embodiments of the present invention.

### DETAILED DESCRIPTION OF ILLUSTRATIVE EMBODIMENTS OF THE INVENTION

Illustrative embodiments of the present invention include but are not limited to methods and apparatuses for facilitating, by a computer system, specifying and associatively storing a locator for a data item stored in a storage location, and a characterization of the data item. The locator is a link that identifies the storage location. In various embodiments, the characterization system may be used much like file folders to group data items.

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation specific numbers, materials, and configurations are set forth in order to provide a thorough understanding of the illustrative embodiments. However it will be apparent to one skilled in the art that alternate embodiments may be practiced without the specific details. In other instances, well-known features are omitted or simplified in order not to obscure the illustrative embodiments.

Further, various operations will be described as multiple discrete operations, in turn, in a manner that is most helpful in understanding the illustrative embodiments; however the order of description should not be construed as to imply that these operations are necessarily order dependent. In particular, these operations need not be performed in the order of presentation.

The phrase “in one embodiment” is used repeatedly. The phrase generally does not refer to the same embodiment; however, it may. The terms “comprising,” “having,” and “including” are synonymous, unless the context dictates otherwise. The phrase “A/B” means “A or B”. The phrase “A and/or B” means “(A), (B), or (A and B)”. The phrase “at least one of A, B and C” means “(A), (B), (C), (A and B), (A and C), (B and C) or (A, B and C)”. The phrase “(A) B” means “(B) or (A B)”, that is, A is optional.

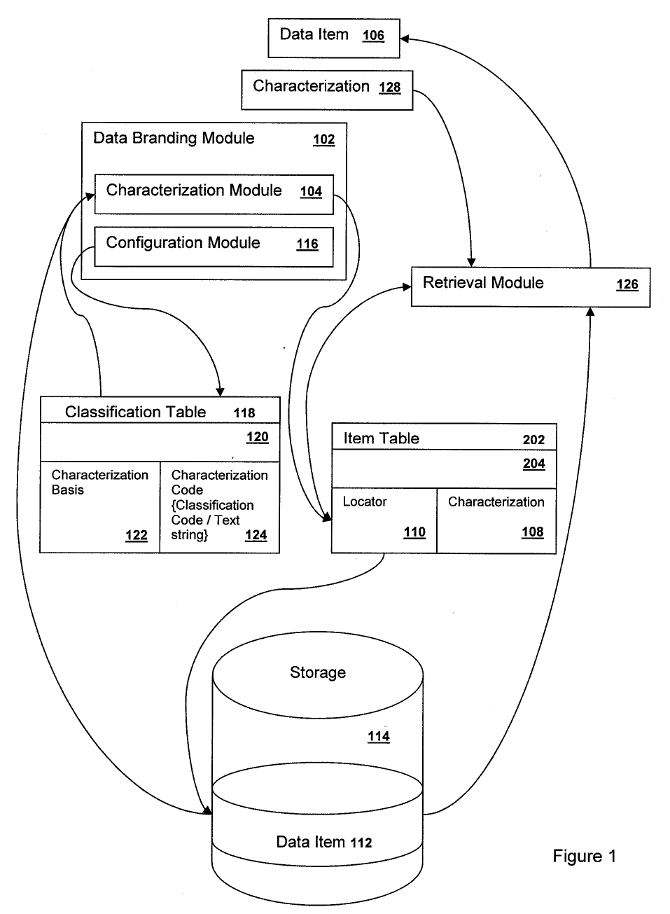

FIG. 1 illustrates an overview of the invention, in accordance with various embodiments. As illustrated, a computing environment may contain a number of data items stored at various storage locations, including e.g. data item 112 stored at storage 114. A data item 112 may be in the form of a data file, a multi-media file, or any other file type. The logic of the computing environment may at least be in part as a result of using a Data Branding module 102. The Data Branding module 102 may, when the data item 112 is selected, perform operations associated with the data item 112 using sub modules of the Data Branding Module 102. Once a data item 106 is selected for inclusion into the Data Branding system, the Characterization module 104 is executed allowing a Characterization 108 to be associated with a Locator 110 of the data item 106. The Characterization 108 may be made up of one or more Classification codes and/or Text strings that may be added by the user or a third party. The Locator 110 is a hyperlink. It may be a physical address, a path, or a link to other similar entities associated with the data item 112. In some embodiments the Locator 110 may be a uniform resource locator (URL) of the data item 112. In other words, the physical storage location of the data item 112 within a storage 114 is known by the data branding module 102 through the Characterization 108 associated with the Locator 110. The storage locations may be local to the computer system or may be accessible via a network and need not to be known by the computer user. For the illustrated embodiments, Locators 110 and the associated Characterizations 108 for various branded data items 112 are associatively stored in Item Table 202. In alternate embodiments, other associative manner of storing Locators 110 and the associated Characterizations 108 may be practiced instead.

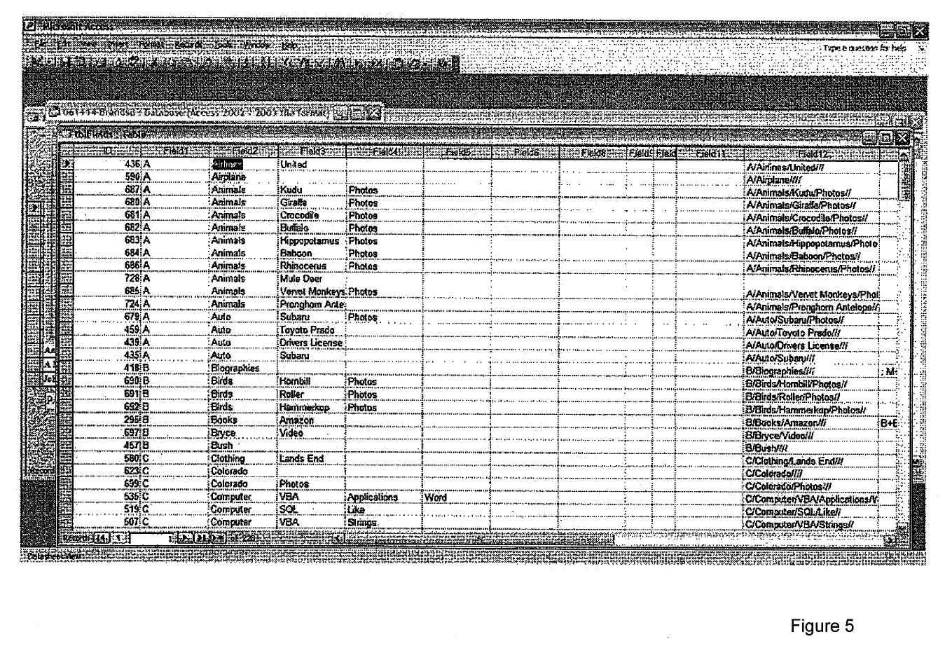

Additionally, for the illustrated embodiments, the configuration module 116 is configured to enable creation of a Classification table 118 and the Characterizations stored therein, if they are not in existence. When adding a Characterization to the Classification table 118, a row 120 may be created in the table, where Characterization 108 comprising a Classification code and/or a Text string may be added. Characterization 122 is a parsed version of Characterization 108, with separate sections (delimited by “/”) of Characterization 108 each placed in individual columns (see FIG. 5). The Characterization module 104 brands data items 112 with Characterization 108. Multiple Characterization 108 brands can be branded into the characterization column of each data item 112, giving a data item multiple characterizations. This enables the user to retrieve data item 112 under various characterizations (see Retrieval module 126 below), and has the same effect as if multiple copies of data item 112 had been made for different characterizations—the same locator 110 is used for all characterizations of data item 112. Characterizations 108 are associated with Locators 110 for data items in Item table 202 and arranged in a manner that may be more efficient or intuitive for retrieval to the computer system user. For the illustrated embodiments, Retrieval module 126 is provided to facilitate retrieval of data items by selecting only those with particular brandings or Characterizations 108. Working via Characterization 108, the Retrieval module 126 may select data item 112 bearing Characterization 108 and may retrieve the data item 112 from the storage 114 for the computer user, using the corresponding Locator 110 obtained from Item Table 202. Alternatively, the Retrieval module 126 may retrieve data item 112 using a different Characterization 108 associated with Locator 110. Retrieval module 126 may be set so that it not only retrieves all data items 112 with a particular Characterization 108, but upon retrieving them it automatically opens an application associated with the data item 112, following the hyperlink in each Locator 110 for each data item 112, allowing immediate display or execution of the data item 112. In alternate embodiments, Retrieval module 126 may also be a part of the data Branding module 102.

In various embodiments, the computing environment described above may comprise one or more of any single- or multi-processor or processor core central processing unit (CPU) computing system. The computing environment may be or include a personal computer (PC), a workstation, a server, a router, a mainframe, a modular computer within a blade server or high-density server, a personal digital assistant (PDA), an entertainment center, a set-top box, a media player, or a mobile device. The computing environment may also be distributed over a cluster of computer systems, in a client-server relationship or in a peer-to-peer relationship, through one or more local area networks, and/or wire area networks. Each computing system of the computing environment may be capable of operating a plurality of operating systems (OS) in a plurality of virtual machines using virtualization technologies. An exemplary single-/multi-processor or processor core computing system of the computing environment is illustrated by FIG. 12, and is described in greater detail below. Hereinafter, including in the claims, processor and processor core shall be used interchangeably, with each term including the other.

In embodiments where the computing environment is comprised of two or more computing systems, the computing systems may be connected by a networking fabric and may each include all or portions of at least one Data branding module 102, Characterization module 104, Configuration module 116, Retrieval module 126, Classification table 118, and Item table 202. The networking fabric connecting the computing systems may be any sort of networking fabric known in the art, such as one or more of a local area network (LAN), a wide area network (WAN), and the Internet. The computing systems may further use any communication protocol known in the art, such as the Hypertext Transfer Protocol (HTTP), and any transport protocol known in the art, such as the Transmission Control Protocol/Internet Protocol (TCP/IP) suite of protocols.

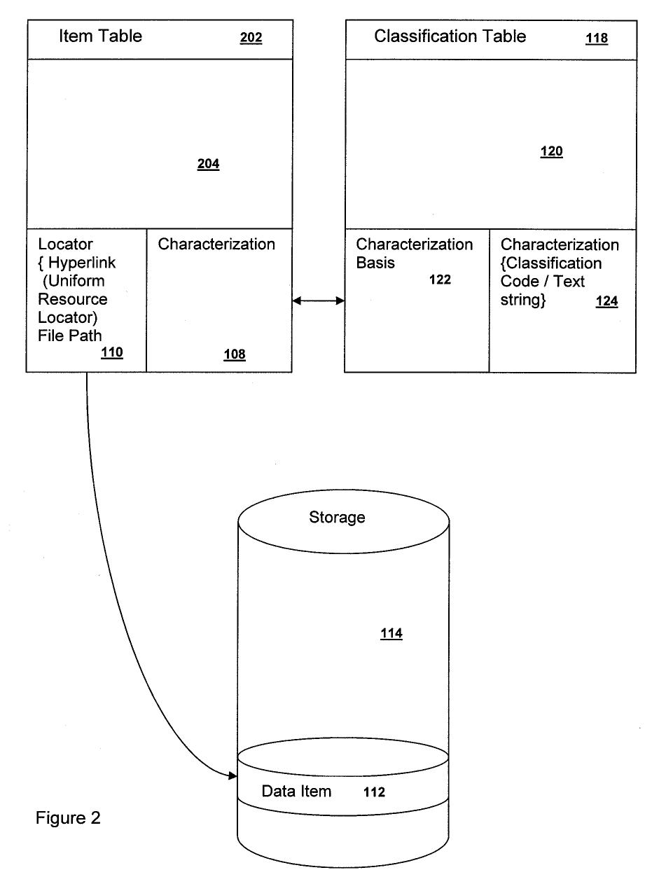

FIG. 2 illustrates, in greater detail, the relationship between the Item table 202, the Classification table 118, and a data item 112 located in a storage 114. In this embodiment, the Item table 202 is made up of rows and columns 204, each row containing one data item 112. Each row includes a Characterization 108 associated with the locator 110 of the data item 112, and the associated Locator 110 provides the means to locate data item 112 stored in storage 114. The means to locate the data item 112 shown may be a Uniform Resource Locator (URL) or the file path, each identifying the physical location of the data item 112. A hyperlink is associated with Locator 110, allowing the data item to be selected and in some embodiments the retrieval of the data item can be executed by selecting Locator 110 with a mouse, keyboard or similar selection device. By selecting Locator 110 to retrieve data item 112, the application associated with the file type may open data item 112 allowing the data item to be immediately executed or displayed in a native application. An example would be viewing image data items immediately in a viewer application with one operation.

A plurality of data items of different file types may be selected and opened sequentially with their associated applications, allowing for groups of associated data items to be manipulated. The classification table 118 in this embodiment may be made up of rows and columns 120. Each row can be made up of columns which as a group form Characterization basis 122, along with a single column in which all the previous columns are concatenated, which is the previously mentioned Characterization 108 code and/or Text string. Characterization basis 122 may be user defined or supplied by a third party. Characterization basis 122 is a parsed version of Characterization 108, allowing the user to selectively choose a hierarchy of characterizations as he/she narrows the selection and approaches the particular Characterization 108 for each data item 112 (or broadens the selection away from the particular Characterization 108 for each data item 112). Hierarchical selections provide an efficient and intuitive means to view groupings of data items 112. In any case, grouping data items 112 by selecting for a particular Characterization 108 brand or by parsing of Characterizations 108 (eg. Characterization basis 122) allows for operations to be carried out on the group of data items sequentially. For example, once a group of items has been identified, the items may be printed in groups, attached as email attachments, opened in groups if photographs, opened in groups if web site addresses, activated (played) in sequence if music files, or manipulated by some other means on the computer system.

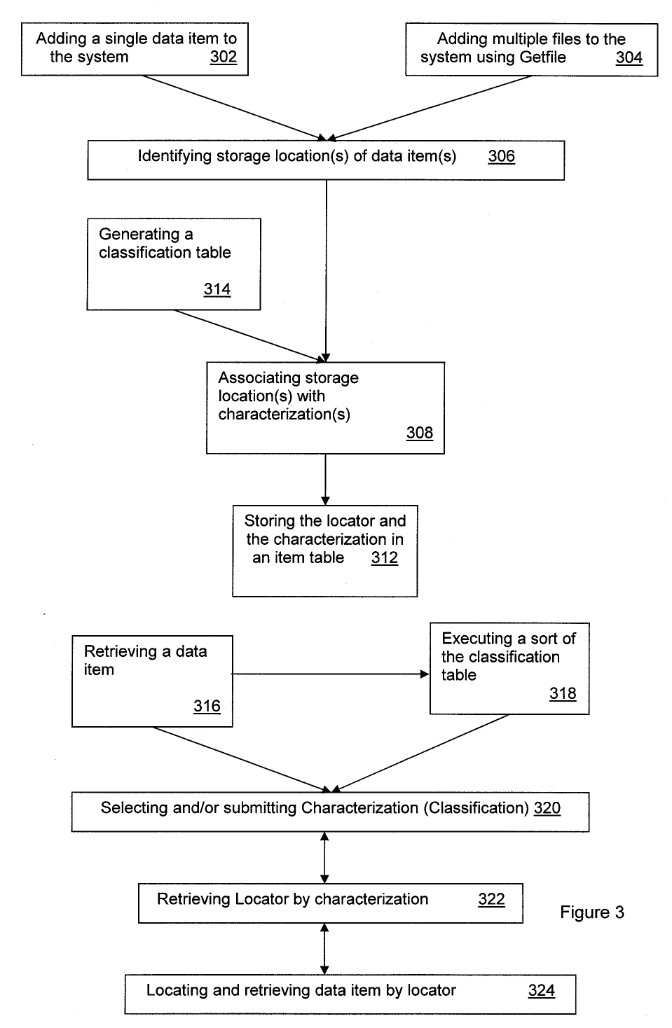

FIG. 3 is a flow chart depicting various embodiments of the invention for characterizing a data item and manipulating the data item through its Characterization. As illustrated, a computing environment may receive or contain a data item located within the storage of the computer system. A data item may be added as single data item to the system using method 302 or by adding multiple data items to the system using Getfile method 304. The term “method” as used herein is to be read as it is understood by those of ordinary skill in the art of object oriented programming; however the invention is not limited to an object oriented implementation.

The Getfile method 304 is similar to a batch operation where multiple data items may be selected from Storage 114 and their Locator 110 values added to the Item table 202 as a batch, with their Locators 110 linking them back to actual data items in Storage 114. This embodiment may also allow the association of third party text string descriptions and classification codes to be added as Characterization basis 122 column entries to Classification table 118. In this way, music data items could be imported and stored in Storage 114; their Locators 110 imported into the Item table 202; then classification codes and text strings identifying, among other things, title, artist, composer, genre, track length, year of production, country of origin, and so forth assigned to the Characterization basis 122 in the Classification table 118. In various embodiments, the data item can be located in any physical storage location, local or remote, known or unknown to the user. The data item Locator is a hyperlink to a file path, a uniform resource locator or other means to locate the physical location of the data item, and is associated with the Characterization of the data item because both locator and characterization are column entries for each data item row in an Item table 202. The association allows the Characterization always to be associated with the physical location of the data item regardless of the physical location of the storage location. A Classification code and or Text string describing the data item can be supplied by a third party as noted above, or user defined. In this embodiment the user can edit the Classification code and/or Text string, the language being completely freeform, and so allowing the user to use terminology and codes that are most efficient and intuitive to each situation.

The Classification table may be generated separately from the Item table. The generated Classification table may contain rows and columns, each row containing a number of Characterization basis and a corresponding Classification code and or Text string. Drop down menus on the Item table 202, which are linked to the Classification table 118, are then employed to display Characterization basis 122 entries so that they can be collectively branded as Characterizations 108 onto a row of the Item table 202 in the relevant column. Since each row has a data item locator in it, the Characterizations 108 become linked to the locator once they are branded into their column in the row. The result is stored within an Item table 312, the Item table being made up of rows and each row containing the locator and characterization basis for one data item. The rows representing the data items can be arranged in any order using the characterization.

Sorting and grouping of data items may be carried out on the Item table, allowing for fast, efficient, intuitive navigation and retrieval of data items 316. Retrieval of a data item 316 may be by selection of a Characterization 320, which can be associated with a Locator The Locator may contain the physical address of the data item, allowing the selected item to be opened. For this embodiment, the data item may be opened with it's associated application. The Classification and or Text string details of a data item can be edited, allowing a user to modify these terms, and allows for future efficiencies to be built into the Classification table. A data item may be located by retrieving the Locator by Characterization 322 if all or part of the Characterization is known. Once the appropriate locator has been found through its association with the Characterization, a data item can be located and/or retrieved by the Locator 324. Data items may be searched for using all or part of the Classification code and or Text string; this allows a user to find a data item based on any known recorded characteristic of the data item. Also, this allows the user to retrieve data items as hierarchical sets of related groupings, as the Characterization 108 value is parsed into smaller units. Further, as already mentioned earlier, since each data item can be multi-branded with multiple Characterizations 108, the user has multiple terms to retrieve a particular data item, making for very fast and easy retrieval. Further still, any number of useful characterizations may be branded into the characterization column (in fact, multiple characterizations, as already mentioned), including ones such as “to do” or “follow up”, thereby effectively tagging data items for follow up action in addition to their existing characterizations.

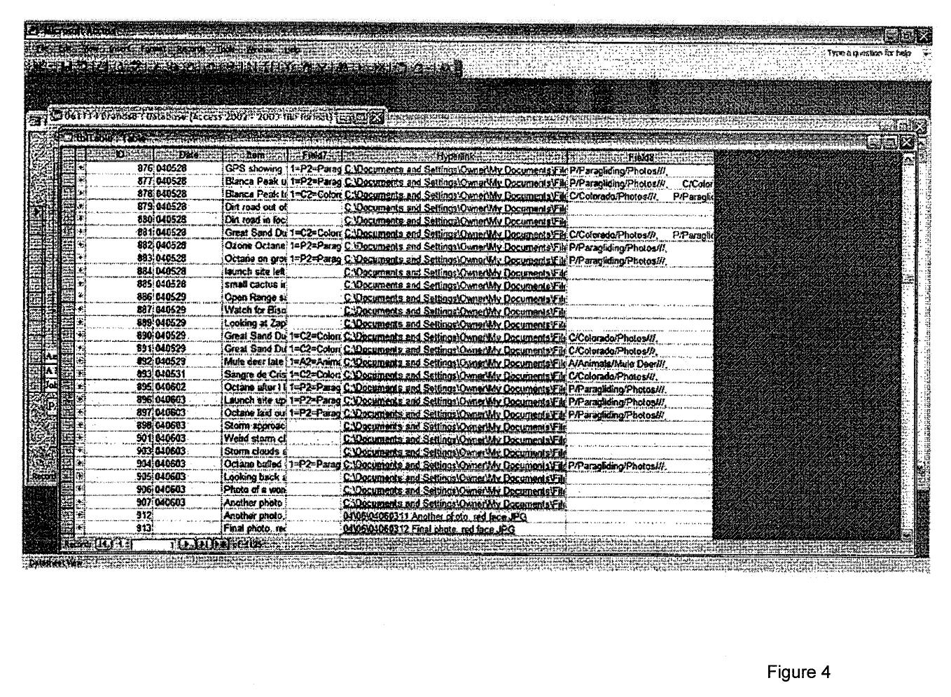

FIG. 4 illustrates an embodiment showing a screen shot of an Item table. Each row of the table contains information specific to one data item. The hyperlink column contains a hyperlink which is the data item Locator, the full file path to the data item. It is not necessary to display the full path to the data item, merely that the full path be called when the hyperlink is activated, and this is shown in this figure. By selecting the hyperlink the user is selecting the data item represented by the row in the table. The column headed Field 8 on the far right of the table represents a column containing Characterization 108 information. In this instance classification codes and text strings are shown.

FIG. 5 illustrates an embodiment showing a screen shot of a classification table. Each row of the classification table contains information specific to one data item. The columns headed Field 2, Field 3, Field 4, and Field 5 contain classification data for the data items contained in the table. The Characterization 108 for each data item is contained in Field 12 of the table. The table demonstrates a classification table sorted on Field 2, with the data item possibly representing a United Airlines ticket. The 3^{rd} to 9^{th} rows give an example of a grouping of data items; the example shows animal photos, including information about the specific animal contained in each photo.

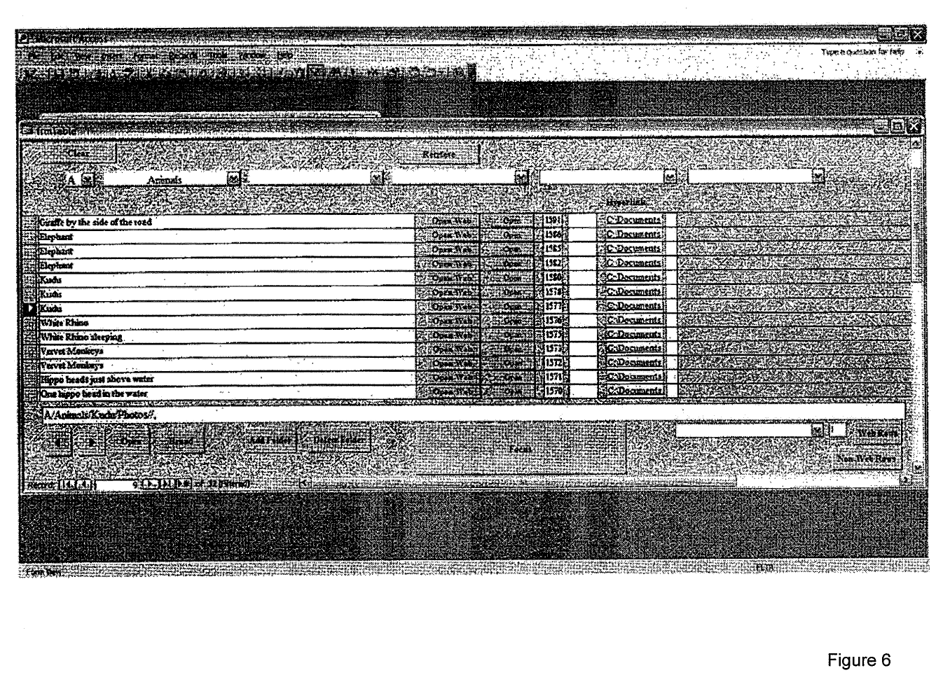

FIG. 6 illustrates an embodiment showing a screen shot of a resulting recordset; a subset of the classification table containing a common classification, each row representing one data item. The table shows all data items with an animal classification, as indicated by the drop down menu entries “A, Animals” under the “clear” button. This would allow all of the data items with the animal classification to be manipulated by the user in one operation.

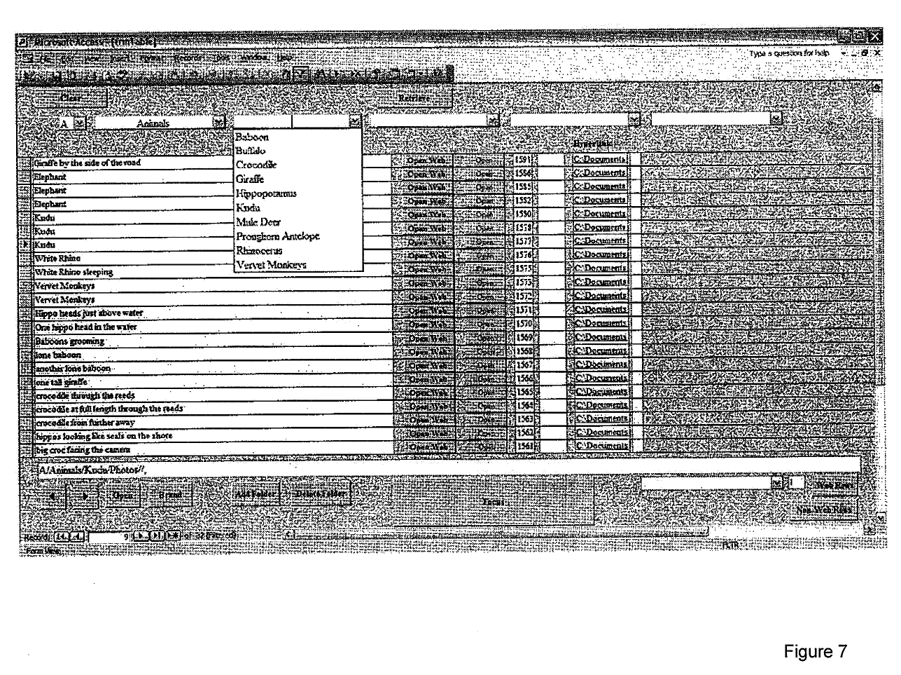

FIG. 7 illustrates an embodiment showing a screen shot of a drop down menu showing various criteria available within a classification table. The drop down menu contains classifications that can be added to the data items in the table. By selecting a data item represented in one of the rows, then selecting classifications from the appropriate drop down menus, and then selecting the branding button, the classifications are added to the data item, creating the data item's Characterization 108.

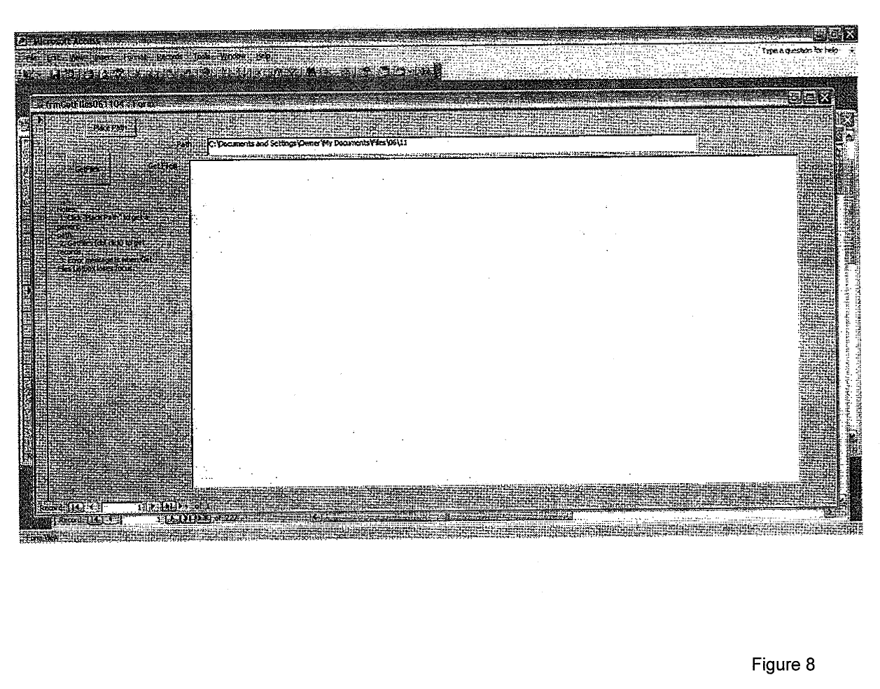

FIG. 8 illustrates an embodiment showing a screen shot of the Getfile form when it is empty; before the Getfile logic is activated. The Path field at the top of the form indicates where the user would enter the file folder location for files he wants entered into the system.

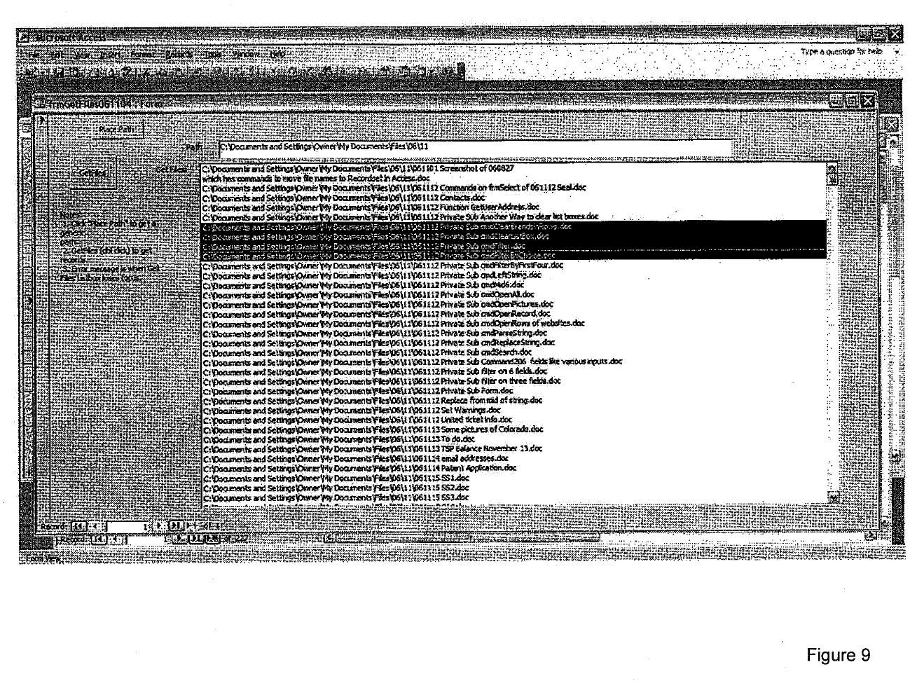

FIG. 9 illustrates an embodiment showing a screen shot of a Getfile form. All of the data items in a specific location or folder are shown listed in the table, each row representing one data item. From the data items shown, a subgroup is selected to be uploaded into the Item table. Each data item in the group selected will have a Characterization and a Locator associated with it in one operation similar to a batch operation, as it is uploaded into the Item table. The user may then brand a Characterization 108 into the row for each uploaded item in the Item table, using drop down menus as already described.

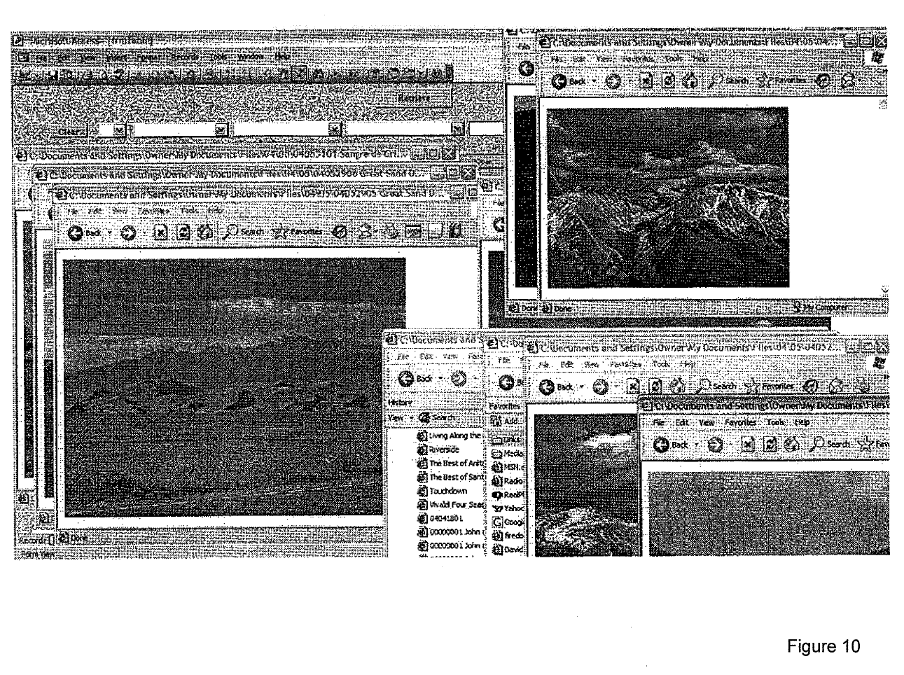

FIG. 10 illustrates an embodiment showing a screen shot of the result of multiple data items being selected and the appropriate associated viewing application being opened for each data item and displaying each data item sequentially on the computer system. This is done because the program performs a “do loop” routine, moving down through rows and opening each photograph via the hyperlink (locator 110) field for each row.

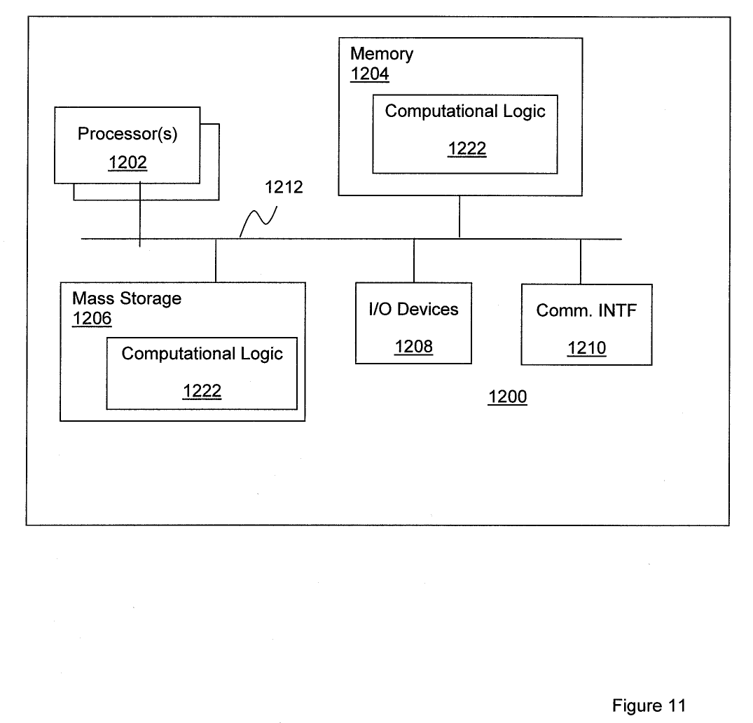

FIG. 11 illustrates an exemplary computing device capable of performing the operations of various embodiments of the present invention. As shown, computing system/device 1200 may include one or more processors 1202, and system memory 1204. Additionally, computing system/device 1200 may include mass storage devices 1206 (such as diskette, hard drive, CDROM and so forth), input/output devices 1208 (such as keyboard, cursor control and so forth) and communication interfaces 1210 (such as network interface cards, modems and so forth). The elements may be coupled to each other via system bus 1212, which represents one or more buses. In the case of multiple buses, they may be bridged by one or more bus bridges (not shown).

System memory 1204 and mass storage 1206 may be employed to store a working copy and a permanent copy of the programming instructions implementing one or more aspects of the above described teachings to practice the present invention, such as computational logic 1214. The programming instructions may be implemented in assembler instructions supported by processor(s) 1202 or high level languages, such as C, that may be compiled into such instructions.

The permanent copy of the programming instructions may be placed into permanent storage 1206 in the factory, or in the field, through e.g. a distribution medium (not shown) or through communication interface 1210 (from a distribution server (not shown)).

Although specific embodiments have been illustrated and described herein for purposes of description of the preferred embodiment, it will be appreciated by those of ordinary skill in the art that a wide variety of alternate and/or equivalent implementations may be substituted for the specific embodiment shown and described without departing from the scope of the present invention. Those with skill in the art will readily appreciate that the present invention may be implemented in a very wide variety of embodiments. This application is intended to cover any adaptations or variations of the embodiments discussed herein. Therefore, it is manifestly intended that this invention be limited only by the claims and the equivalents thereof.

What is claimed is:

1. A method comprising:
first facilitating, by a computer system, specification of a locator and a characterization associated with the locator, the locator associated with a data item stored in a storage location, and the locator identifying the storage location;
storing, by the computer system, associatively the locator and the characterization; and
second facilitating, by the computer system, locating and retrieving of the data item using the characterization.

2. The method of claim 1, wherein the specification of the characterization comprises a classification code associating the data item with a class of data items or a text string describing the data item.

3. The method of claim 2, further comprising facilitating a user, by the computer system, to define or edit one or more classification codes, or all or a portion of the text string.

4. The method of claim 1, wherein the locator is a hyperlink.

5. The method of claim 4, wherein the hyperlink is associated with one of a uniform resource locator of the data item or a file path of the data item.

6. The method of claim 1, wherein said second facilitating comprises executing a search using the classification code, or using all or a portion of the text string.

7. The method of claim 1 wherein said storing comprises storing the locator and the characterization in a row of an item table having at least two columns and a plurality of rows, one row per data item.

8. The method of claim 1 wherein said first facilitating further comprises specification of at least one other data item stored at least at one other storage location.

9. The method of claim 8 wherein said first facilitating comprises invoking a getfile method to select the data items, and said storing comprises adding the selected data items to an item table.

10. The method of claim 1 wherein said storing comprises storing the locator and the characterization in a row of an item table having at least two columns and a plurality of rows, one row per data item, and said second facilitating comprises executing a select query of the item table based at least in part on the characterization.

11. The method of claim 1, further comprising facilitating creation of a classification table, the classification table having at least two columns, a plurality of rows, each row including at least one classification code for characterization of a data item.

12. The method of claim 11 wherein said second facilitating comprises executing a select query of the classification table based at least in part on the classification codes.

13. An apparatus comprising:
a processor; and
a characterization module operated by the processor and adapted to first facilitate specification of a locator and a characterization associated with the locator, the locator associated with a data item stored in a storage location, and the locator identifying the storage location, and to store associatively the locator and the associated characterization; and
a retrieval module operated by the processor and adapted to second facilitate locating and retrieving of the data item using the characterization.

14. The apparatus of claim 13, wherein the apparatus comprises a data branding module having the characterization and retrieval modules.

15. The apparatus of claim 13, wherein the specification comprises a classification code associating the data item with a class of data items or a text string describing the data item.

16. The apparatus of claim 13, wherein the characterization module is adapted to perform said storing by storing the locator and the characterization in a row of an item table having at least two columns and a plurality of rows, one row per data item.

17. The apparatus of claim 13, wherein the characterization module is adapted to perform said first facilitating by facilitating specification of at least one other data item stored at least at one other storage location.

18. The apparatus of claim 17, wherein the characterization module is adapted to perform said first facilitating by facilitating invocation of a getfile method to select the data items, and said storing comprises adding the selected data items to an item table.

19. The apparatus of claim 13, further comprising a configuration module adapted to facilitate creating a classification table, the classification table having at least two columns, a plurality of rows, each row including at least one classification code for characterization of a data item

20. An article of manufacture comprising:
a storage medium; and
a plurality of programming instructions stored on the storage medium and configured to enable an apparatus to
first facilitate specification of a locator and a characterization associated with the locator, the locator being associated with a data item stored in a storage location, and the locator identifying the storage location,
store associatively the locator and the associated characterization, and
second facilitate locating and retrieving of the data item using the characterization.

21. The article of claim 20, wherein the specification comprises a classification code associating the data item with a class of data items or a text string describing the data item.

22. The article of claim 20, wherein the programming instructions are configured to enable the apparatus to store at least a portion of an item table to facilitate storing the locator and the characterization in a row of an item table having at least two columns and a plurality of rows, one row per data item.

23. The article of claim 20, wherein the programming instructions are configured to enable the apparatus to facilitate, as part of said first facilitate, specification of at least one other data item stored at least at one other storage location.

24. The article of claim 23, wherein the programming instructions are configured to enable the apparatus to perform said first facilitate by invoking a getfile method to select the data items, and to perform said storing by adding the selected data items to an item table.

25. The article of claim 20, wherein the programming instructions are further configured to enable the apparatus to create at least a portion of a classification table, the classification table having at least two columns, a plurality of rows, each row including at least one classification code for characterization of a data item.
